(19) United States
(12) Patent Application Publication
(10) Pub. No.: US 2014/0243473 A1
(43) Pub. Date: Aug. 28, 2014

(54) METHOD AND DEVICE FOR DIRECT, CONTINUOUS MODIFICATION OF POLYMER MELTS

(71) Applicants: Ekkehard Siebecke, Berlin (DE); Mirko Bär, Birkenwerder (DE); Eberhard Raue, Schonfliess (DE)

(72) Inventors: Ekkehard Siebecke, Berlin (DE); Mirko Bär, Birkenwerder (DE); Eberhard Raue, Schonfliess (DE)

(73) Assignee: UHDE INVENTA-FISCHER GMBH, Berlin (DE)

(21) Appl. No.: 14/124,296

(22) PCT Filed: Jun. 5, 2012
(86) PCT No.: PCT/EP2012/060618

§ 371 Date: May 13, 2014

(30) Foreign Application Priority Data
Jun. 8, 2011 (EP) 11004672.9

(51) Int. Cl. C08G 69/46

(52) U.S. Cl. CPC C08G 69/46
USPC 524/606; 528/323; 422/119

(57) ABSTRACT

The invention relates to a method for direct, continuous modification of polymer melts with additives in the side stream and is distinguished by a very high degree of flexibility in product change-overs.

The invention relates to a method for direct, continuous modification of polymer melts with additives in the side stream and is distinguished by a very high degree of flexibility in product change-overs.

For various reasons, polymer melts must be modified with additives. One reason is that polymer melts are more or less transparent because the homogeneous structure of the synthetic polymers does not offer light any possibility for refraction or reflection. Therefore polymer melts are mixed with pigments, such as e.g. TiO₂, ZnS or carbon black, for the most varied of applications. In particular in the field of synthetic fibres, it is desired to remove the unattractive and greasy shine from the melt before spinning, which has a disturbing effect in particular when using synthetic fibres in the clothing field. Refraction of the shine is effected by the addition of a relatively small quantity of white pigment, generally titanium dioxide. However, also for further purposes, such as e.g. for production of anti-pilling fibres or for optical brightening of e.g. yellowish polymers, the modification of polymer melts by the addition of additives is known.

Melt modification methods using masterbatch melts are state of the art. This principle is described for example in DE-OS 16 04 368. A melt made of masterbatch granulate, with a high percentage of additive, is mixed into the polymer melt to be modified downstream in a defined ratio. This method does in fact offer high flexibility with quality change-overs but has the following disadvantages: firstly the masterbatch granulate must be dried before melting.

Secondly, during remelting it experiences an additional thermal and mechanical loading. The third disadvantage of this method is the additional handling costs. Another disadvantage is the danger of external contamination of the granulate. In the case of in-house masterbatch production, there is the further disadvantage that polymer granulate must be removed from the production process. The disadvantage of masterbatch extraneous granulates is the differences between the polymers which are used and which disadvantageously influence the properties of use of the end product.

One modification variant is described in the publication Chemical Engineering Progress 78 (1982) 1, pp. 62-64. Instead of the downstream additive addition to the polymer melt, here both the polymer granulate and the preferably reactive additives are fed in in the first extruder region. The disadvantage of this method is, on the one hand, the danger of compacting of the additive between the granulates and, on the other hand, the high shear stresses which are necessary for homogenisation and dispersion and lead to a great and uncontrollable reduction in viscosity of the polymer.

A further method associated with the state of the art is described in the publication “Chemiefasern and Textilindustrie 1” (Chemical Fibres and Textile Industry 1) (1986), pp. 24 -29. Here a partial stream is branched off from a main melt stream emerging from the polycondensation end reactor and an additive is incorporated in the melt downstream. This melt laden with additive is returned again to the main melt stream. This method also has a high degree of flexibility in the case of additive change-overs but several substantial disadvantages. Firstly, volatile components contained in the polymer melt, such as e.g. glycol- and water vapours or oligomers, escape through the feed funnel, despite suctioning, during the additive addition. This leads to reduced pourability of the additive and to the formation of lumps. Additive agglomerates can no longer be incorporated homogeneously in the melt and, during the spinning process, cause filter blockages and also weak points in the threads. In addition, a continuous and uniform additive metering is impaired by the convection current of the melt which keeps the additive particles, generally supplied in free fall, hovering at the addition point. A further disadvantage is that the extruder opening for the additive addition must be kept small in order to reduce the danger of melt emerging at this point. Hence, also the quantity of additive is limited.

With increasing production output of the continuous polycondensation plants, only production lines with a high degree of flexibility are economical. Often, parallel production of different types of product, such as e.g. fibres and granulate, must be possible on a single production line at the same time. The change-over to different product qualities, such as e.g. non-matt, matt or pigmented, must hereby be ensured within the shortest time and with as low a loss as possible. These requirements are fulfilled only inadequately with the method available in the state of the art.

The object of the present invention was therefore to develop a method and a device for direct, continuous modification of polymer melts without the disadvantages described in the state of the art.

This object is achieved by the melt modification method in the side stream according to the invention having the characterising features of claim 1 and also the device for implementing the method according to the invention having the characterising features of claim 12.

According to the present invention, a method is hence provided for continuous production of polyamide 6 or copolyamides which are formed from at least 70% by weight of repeat units derived from ε-caprolactam, having the following steps:

a) provision of the educts,

b) formation of a prepolymer and polycondensation of the prepolymer with production of a main melt stream,

c) granulation of the polymer melt,

d) extraction of the polyamide granulate and also

e) drying,

a partial quantity being removed from the main melt stream (b) and the partial quantity being mixed in a side stream in an extruder with a defined quantity of an additive and the modified side stream being returned to the main melt stream (b) downstream before the granulation (c) and the aqueous extract solution formed during the extraction (d), which comprises educts, such as e.g. ε-caprolactam, being concentrated and returned to the initial process (a).

The particular property of the method according to the invention is hence the combination of feeding an additive into a side stream of a prepolymer which is produced by polycondensation and removed from a main melt stream, with a simultaneously effected extraction of the polyamide granulate produced after combining the main melt stream with the partial melt stream. By combination of the addition of the additive into a partial stream and also the subsequent extraction of the granulate, an extremely precise homogenisation of the additive to be added is obtained in the polymer granulate; at the same time, non-polycondensed educts, such as for example caprolactam or short-chain condensates which are undesired in the products, such as e.g. dimers and/or oligomers of the caprolactam, can likewise be removed from the products almost completely. The method according to the invention therefore enables the production of very high-quality polyamide granulates, in the case of which the additives are present extremely homogeneously in the product and which at the same time are free of educts, such as for example caprolactam, which would permanently impair the properties. A further advantage of the method according to the invention is the high degree of flexibility.

Additive change-overs can be undertaken promptly and practically without loss, without cost-intensive cleaning operations and without reduction in product qualities outside the specification. Additive carrier polymers are not necessary so that no disadvantageous influence on the properties of use of the end product results. The method according to the invention concerns a closed process: consequently, no complex interventions in the production process are necessary, such as e.g. the production of in-house masterbatches. No emergence of polymer melt and/or of volatile components takes place during the additive addition. Agglomerate-free modification of the melt and hence extended filter lifespans are possible and substantially lower screw speeds of rotation are required than in the state of the art. No drying of the additive takes place and nevertheless, at the same time, only a minimal and constant reduction in viscosity of the polymer melt. In addition, the possibility arises of dimensioning the extruder opening for the additive addition to be as large as the overall screw cross-section. Limiting the quantity of additive added or the melt throughput is not necessary. Continuous and uniform metering in of the additive into the first extruder region without convection current problems can be effected without an additional cooling possibility of the first extruder zone when using temperature-sensitive additives. Use of the processing aids corresponding to the state of the art is not necessary.

A preferred embodiment of the method according to the invention provides that the main melt stream (b), after branching-off of the side stream, is divided downstream into at least two partial streams and the modified side stream is returned into at least one partial stream in a defined ratio, subsequently there being effected respectively in the partial streams, granulation (c), extraction (d) and drying (e).

A further preferred alternative embodiment of the method according to the invention provides that the main melt stream (b) is divided into three partial streams and the modified side stream is returned into two partial streams in defined ratios.

However, splitting of the main melt stream into more than three partial streams is likewise possible. According to the previously described preferred embodiments of the method according to the invention, it is possible to modify the two or three or more partial streams, for example with different quantities of the additive. It can thereby be provided that, in a first partial stream, absolutely no additive is fed in so that, after completion of the granulation, extraction and drying, additive-free polyamide is obtained in this partial stream line.

Likewise, it is preferred to provide both or all partial streams with different quantities of additives so that three polyamides with different additivity can be produced at the same time in one plant line.

Finally, a preferably aqueous extraction of the produced polymer granulate is effected in each partial stream, non-reacted educts or short-chain condensates being extracted from the polyamide granulate. It is thereby particularly preferred if the extract water flows obtained from the aqueous extraction are guided together, condensed and the thus recovered educts, such as for example ε-caprolactam or dimers and/or oligomers hereof, are supplied again to the polycondensation step b). This embodiment makes it possible, in an economically and ecologically efficient manner, to convert as high a proportion as possible of the educts into correspondingly high-quality products whilst saving resources. As a result of the fact that the extract water from the different partial streams can be guided together and condensed in common there, economic advantages result since simultaneous production of a plurality of product lines of polyamide granulates is possible but only a single extract water condensation device is required. The thus recovered educts can be supplied again to the common polycondensation.

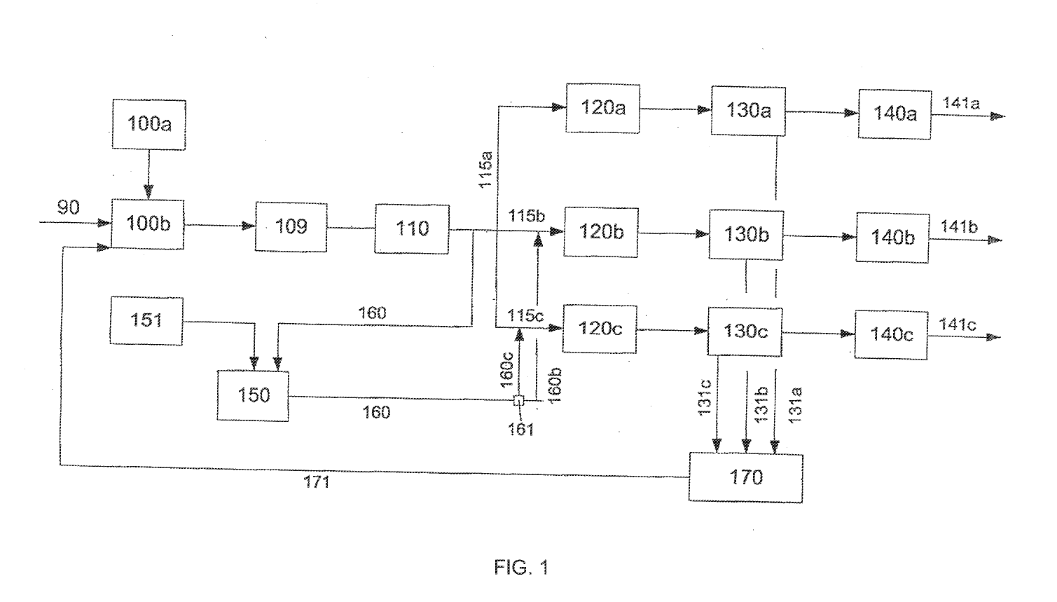

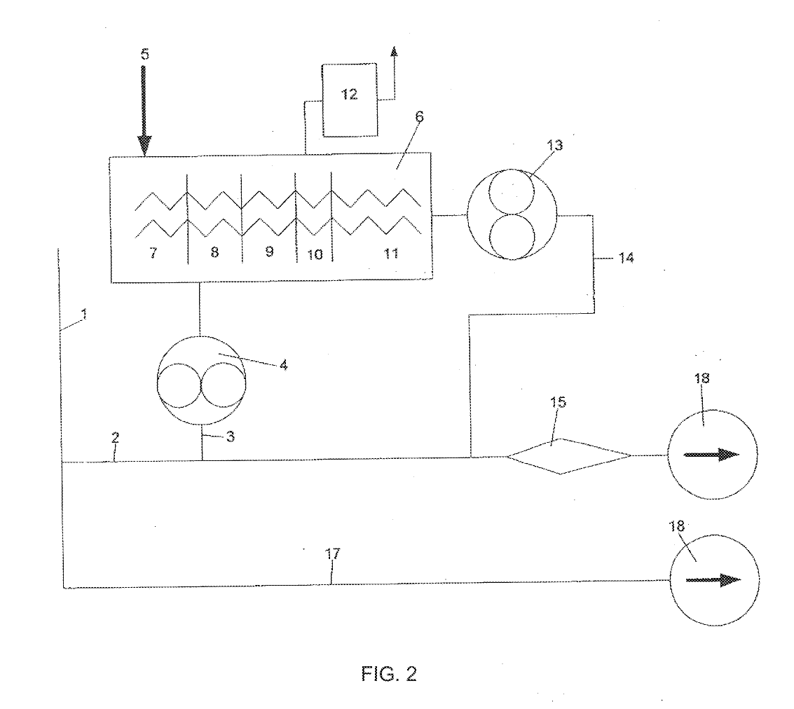

In a further preferred embodiment, it is provided that the additive is metered into a twin-shaft extruder with different treatment regions. Such an extruder is described for example in DE 40 39 857 A1. With respect to the particularly preferred embodiments of corresponding extruders with different treatment regions, reference is made correspondingly to this published patent application, in particular to FIGS. 1 and 2 of this published patent application and also the associated description. The disclosure content of DE 40 39 857 A1 is also made the subject of the present application in its entirety with respect to the preferably used twin-shaft extruder by reference to the corresponding disclosure passages.

It is particularly preferred if a soluble or insoluble, mineral or organic pigment, preferably titanium dioxide, is used as additive.

It is likewise preferred if the additive is metered into the extruder under protective gas, preferably N₂.

In a further preferred embodiment, the extruder is operated under protective gas, preferably N₂.

Preferred quantities of the additive to be added to the main melt stream b) to be modified are thereby between 0.01 and 16% by weight, preferably between 0.03 and 0.6% by weight. The quantity of additive is thereby relative to the total weight of the main melt stream.

A further preferred variant of the method according to the invention provides that the aqueous extract solution formed during the extraction (d) comprises up to 15% by weight of ε-caprolactam and oligomers/dimers and, after concentration, the extract concentration is 70 to 95% by weight.

Likewise, it is advantageous if virgin lactam is added during or after the concentration of the extract solution.

In a particularly preferred embodiment, the aqueous extract solutions present in the respective partial streams are concentrated together.

According to the invention, a device for implementing the previously described method is likewise indicated, which device comprises at least one metering unit, at least one condensation device, at least one granulation device, at least one extraction device and at least one drying unit which are disposed downstream in succession, an extruder being disposed in a bypass between the at least one condensation device and the at least one granulation device, and the at least one extraction device is connected to at least one evaporation unit.

A preferred embodiment of the device according to the invention provides that the twin-shaft extruder has a metering region, a melt inlet region, a wetting region, a degassing region and a dispersion region.

In particular, the screw diameter is reduced by 0.2 to 4 mm in the metering region of the twin-shaft extruder.

A particularly preferred extruder which can be used for the method according to the invention is a co-rotating twin-shaft extruder.

Reference is made to DE 40 39 857 A1 with respect to these embodiments.

It is further preferred if a device for forming a prepolymer is connected prior to the condensation device.

With the metering unit of the device according to the invention, the educts which are supplied to the condensation device can be metered precisely. At the same time, for example also the addition of catalysts etc. is possible via the metering unit.

With the at least one condensation device, a polyamide can be produced subsequently from the educts which are used. The condensation device can thereby also have a two-part configuration and consist for example of a device for forming a prepolymer and also a polycondensation device.

A granulate can also be produced from the polyamide melt with the granulation device. The granulation device or pelletising device can thereby be configured in any manner. There are thereby possible, for example strand granulation devices, die-face granulation devices or underwater granulation devices.

Likewise, all devices known from the state of the art can be used as extraction device or as drying unit.

The extruder disposed in a bypass between the condensation device and the granulation device serves thereby for the addition of the additive. The additive can thereby be stored for example in a storage unit and be fed in specifically via the extruder which is disposed in the bypass.

A preferred embodiment provides that the main melt stream conducted out of the condensation device is subsequently divided into two or more partial streams. Before the branching-off of the main melt stream into the said partial streams, the bypass which branches the side stream into the extruder is discharged however from the main melt stream emerging from the condensation device. The bypass thereby ends preferably in at least one of the thus produced partial streams, preferably in a plurality of partial streams. Hence, polyamide melt lines with different additivity can be produced with the device.

For further preference, the device according to the invention comprises an evaporation unit for recovering the extract. In the case where, as described above, a plurality of partial streams are produced from polyamide melts with different additivity, each of the partial streams has a separate granulation device, extraction device and drying device. In this case, it is preferred that the extracts obtained from the respective extraction devices, in particular the monomer-containing extract water, are supplied to an evaporation unit which is connected subsequent to the respective extraction devices for evaporation of the obtained extract water. Water is removed at least partially in such an evaporation unit. The concentrated educts or oligomers of these educts which are obtained, in particular ε-caprolactam or dimers and/or oligomers hereof, can be fed again into the metering device and hence supplied again to the polycondensation.

The present invention is explained in more detail with reference to the subsequent Figures without restricting the invention to the special embodiments represented there.

There are thereby shown

FIG. 1 a device for implementing the method according to the invention, which comprises three partial streams;

FIG. 2 a section from the polycondensation device represented in FIG. 1; and also

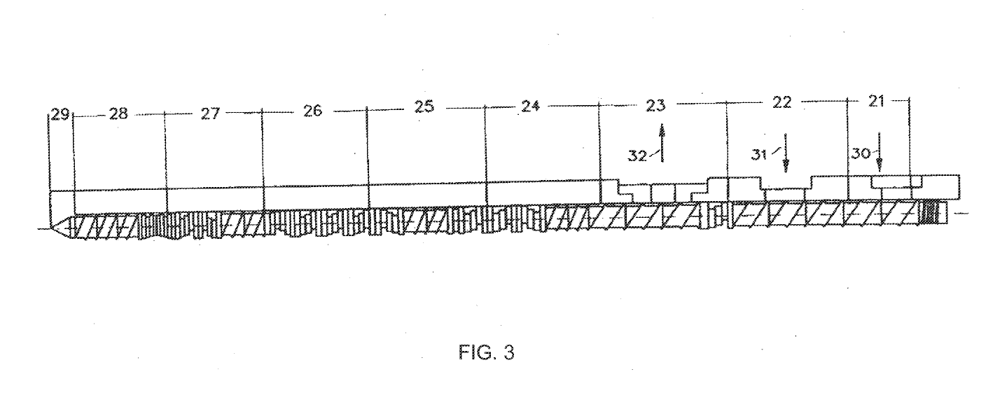

FIG. 3 a screw, given by way of example, which can be used in an extruder in the device according to the invention.

FIG. 1 shows a device for the production of different polyester granulate lines according to the present invention. An ε-caprolactam stream 90 is thereby supplied to a metering device 100b. The metering device can supply, to the educt used, i.e. to the ε-caprolactam stream 90, for example additives, in particular catalysts etc., which can be stored for example in a device 100a. At the same time, the quantity of ε-caprolactam can be metered specifically. The produced educt mixture is supplied subsequently to a condensation device which has a two-part configuration in the form of a prepolymerisation- or precondensation reactor 109 and also in the form of a postcondensation reactor 110 in the example according to FIG. 1. One part of the main melt stream emerging from the polycondensation device is thereby supplied in a bypass 160 to a suitable extruder 150. By means of this extruder, additives which can be stored for example in a device 151 can be supplied to the side stream in the bypass 160. After branching-off of this side stream, the main stream is divided into three lines 115a, 115b and 115c and supplied respectively to granulation devices 120a, 120b and 120c. In these different lines 115a, 115b or 115c, respectively one part of the side stream which is branched-off into the bypass 160 and modified by means of the extruder 150 is supplied. The side stream 160 is thereby divided by means of a switch 161 into a plurality of partial streams 160b and 160c which open respectively into the side lines 115b or 115c. According to the example in FIG. 1, only modification of the side streams 115b and 115c is undertaken with the device, whilst the side line 115a remains unmodified, i.e. has no additivity. However it is likewise possible to feed also a partial quantity of the side stream guided in the bypass 160 into the side line 115a. By means of the switch 161, for example degrees of additivity of the side lines 115b and 115c can be adjusted. After completion of the granulation, respectively an extraction of the produced granulate is effected by means of respectively one extraction device 130a, 130b and 130c which are disposed respectively in the side lines 115a, 115b and 115c and are connected subsequent to the respective pelletising device 120a, 120b and 120c. The extract water, which is obtained during the implemented aqueous extraction and comprises for example caprolactam as educt or dimers hereof and/or water-soluble short-chain oligomers, is supplied to an evaporation unit 170 via extract water lines 131a, 131b and 131c and collected there. A common evaporation of the extract water obtained from the individual side lines 115a, 115b and 115c takes place. According to the management of the method, the degree of evaporation of this extract water can be adjusted specifically. The obtained concentrated extracts which are hence rich in caprolactam or short-chain and still reactive oligomers can be supplied to the metering device 100b via a collection line 171 and fed to the virgin lactam stream 90. In the respective side lines 115a, 115b and 115c, the extracted granulate is subjected subsequently to a drying by means of corresponding drying devices 140a, 140b and 140c. Respectively granulate 141a, 141b and 141c with different additivity is obtained subsequent to the drying process. In the example of the diagram illustrated in FIG. 1, the polyamide granulate 141a is additive-free, the polyamide granulate 141b has partial additivity (has therefore a smaller degree of additivity of additive, compared with the polyamide granulate 141c) and the polyamide granulate 141c has “complete” additivity.

FIG. 2 represents a detailed reproduction of a detail of the device according to the invention or of the method according to the invention. A method course up to pelletisation is illustrated, i.e. the extraction- and drying steps mentioned in FIG. 1 are not illustrated in FIG. 2. FIG. 2 serves for clarification of the principle of additive addition in the side stream by means of a special extruder.

In FIG. 2, 1 denotes the main melt stream, 2 the partial melt stream optionally to be modified, 3 the side melt stream to be modified, 4 the feed pump, 5 the additive addition device, 6 the twin-shaft extruder, 7 the metering region, 8 the melt inlet region, 9 the wetting region, 10 the degassing region and 11 the dispersion region, 12 the degassing device, 13 the recirculating pump, 14 the modified side stream, 15 the static mixing element, 16 the spinning place, 17 the unmodified partial melt stream and 18 the granulator.

The polymer main melt stream is divided into various partial melt streams, respectively according to the number of desired different types of products: in the example of FIG. 2 for the production of optionally matt or non-matt melt for direct spinning 16 and for the production of unmodified crude granulate 17. A side melt stream 3 is in turn branched-off from the partial melt stream 2 optionally to be modified and is supplied by a metering feed pump 4 into a twin-shaft extruder 6 which is provided with specially designed screw elements and has a plurality of treatment regions 7 to 11. In the first extruder region (metering region 7), the additive metered by an addition device 5 as solid material is drawn in and conveyed in the second region, melt inlet region 8, in which the partial melt stream is guided towards the additive and, in a third extruder region (wetting region 9), the wetting is effected, subsequently conveyed in a fourth extruder region (degassing region 10) with degassing device 12 and is degassed and, in a fifth extruder region (dispersion region 11), the dispersion then is effected according to the state of the art known to the person skilled in the art. The thus obtained additive melt concentrate is metered again into the partial melt stream 2 which is to be modified via a recirculating pump 13 and is reconverted homogeneously in a static mixing element 15.

With the method according to the invention and also the device thereof, polymer melts can be modified with 0.015 to 16% by weight, preferably 0.03 to 0.6% by weight, particularly preferred 0.3% by weight, of additive, without difficulty.

FIG. 3 shows, as embodiment by way of example, a co-rotating twin-shaft extruder of the company Berstorf Type ZE 40A with heatable and coolable zones: 21 metering zone, 22 melt inlet zone, 23 degassing zone, 24 28 dispersion zones, 29 screw head, 30 additive metering, 31 polymer melt supply and 32 degassing.

A device for implementing the method according to the invention consists at least of one feed pump 3, a specially designed twin-shaft extruder 6 with additive addition-5 and degassing device 12 and the treatment regions 7 to 11, a recirculating pump 13 and a static mixing element 15, the additive addition device 5 being preferably a vertical pipe, the specially designed twin-shaft extruder 6 being a preferably co-rotating twin-shaft extruder which has specially designed screw elements in the first extruder region (metering zone 7), the diameters of which are reduced by 0.2 to 4 mm, preferably 0.5 to 2 mm, particularly preferred 0.5 to 1 mm, has feeding elements in the known manner in the second extruder region (melt inlet zone 8), has kneading elements and baffles in the third extruder region (wetting zone 9), is fitted with feeding elements in the known manner in the fourth extruder region (degassing region 10), is equipped in the known manner alternately with feeding and kneading elements in the fifth extruder region (dispersion region 11) and the metering region 7 can be cooled when using temperature-sensitive additives.

1. A method for continuous production of polyamide 6 or copolyamides which are formed from at least 70% by weight of repeat units derived from ε-caprolactam, having the following steps:
a) provision of the educts,
b) formation of a prepolymer and polycondensation of the prepolymer with production of a main melt stream,
c) granulation of the polymer melt,
d) extraction of the polyamide granulate and
e) drying,
wherein
a partial quantity is removed from the main melt stream produced in step b) and the partial quantity is mixed in a side stream in an extruder with a defined quantity of an additive and the modified side stream is returned to the main melt stream produced in step b) downstream before the granulation step c) and in that the aqueous extract solution formed during the extraction step d), which comprises ε-caprolactam, is concentrated and returned to step a).

2. The method according to claim 1, wherein the main melt stream produced in step b), after branching-off of the side stream, is divided downstream into at least two partial streams and the modified side stream is returned into at least one partial stream in a defined ratio, and in that subsequently there is effected respectively in the partial streams, granulation step c), extraction step d), and drying step c).

3. The method according to claim 2, wherein the main melt stream produced in step b) is divided into three partial streams and the modified side stream is returned into two partial streams in defined ratios.

4. The method according to claim 1, wherein the additive is metered into a twin-shaft extruder with different treatment regions.

5. The method according to claim 1, wherein a soluble or insoluble, mineral or organic pigment, is utilized as additive.

6. The method according to claim 1, wherein the additive is metered into the extruder under protective gas.

7. The method according to claim 1, wherein the extruder is operated under protective gas.

8. The method according to claim 1, wherein the main melt stream produced in step b) to be modified is modified with 0.01 to 16% by weight of additive.

9. The method according to claim 1, wherein the aqueous extract solution formed during the extraction step d) comprises up to 15% by weight of ε-caprolactam and oligomers/dimers and, after concentration, the extract concentration is 70 to 95% by weight.

10. The method according to claim 1, wherein virgin lactam is added during concentration of the extract solution.

11. The method according to claim 2, wherein the aqueous extract solutions present in the respective partial streams are concentrated together.

12. A device for implementing the method according to claim 1, comprising at least one metering unit, at least one condensation device, at least one granulation device, at least one extraction device and at least one drying unit which are disposed downstream in succession, an extruder being disposed in a bypass between the at least one condensation device and the at least one granulation device, and in that the at least one extraction device is connected to at least one evaporation unit.

13. The device according to claim 12, wherein the twin-shaft extruder has a metering region, a melt inlet region, a wetting region, a degassing region and a dispersion region.

14. The device according to claim 13, wherein the screw diameter is reduced by 0.2 to 4 mm in the metering region of the twin-shaft extruder.

15. The device according to claim 13, wherein the twin-shaft extruder is a co-rotating twin-shaft extruder.

16. The device according to claim 12, wherein a device for forming a prepolymer is connected prior to the condensation device.

17. The method of claim 5, wherein titanium dioxide is the additive.

18. The method of claim 6, wherein the protective gas is N₂.

19. The method of claim 7, wherein the protective gas is N₂.

20. The method according to claim 8, wherein the main melt stream produced in step b) to be modified is modified with 0.03 to 0.6% by weight of an additive.
